(19) United States
(12) Patent Application Publication
(10) Pub. No.: US 2002/0154744 A1
(43) Pub. Date: Oct. 24, 2002

(54) Portable terminal device for controlling start of an automatic answering function

(75) Inventor: Ukyo Mori, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/122,349

(22) Filed: Apr. 16, 2002

(30) Foreign Application Priority Data
Apr. 23, 2001 (JP) 124912/2001

(51) Int. Cl. H04M 1/64

(52) U.S. Cl. 379/67.1

(57) ABSTRACT

A portable terminal device comprises a telephone number storage unit and a controller. The telephone number storage unit stores the telephone number of remote users, and first reference information corresponding to the telephone numbers. The controller compares a caller number for a caller with the telephone numbers stored in the telephone number storage unit. The results provided by the comparison of the caller number and the telephone numbers are used to read the first preference information from the telephone number storage unit. The first preference information is used to control a waiting time, beginning upon the arrival of a call, for the caller that continues until the start of an automatic telephone answering function.

### BACKGROUND OF THE INVENTION

1. Field of the Invention

The present invention relates to a portable terminal device, and relates in particular to a portable terminal device having an automatic telephone answering function.

2. Description of the Related Art

A conventional portable terminal device includes a function for recording a message from a caller when the user of the portable terminal device does not answer a call within a predetermined period of time. For such a conventional portable terminal device, however, the same period of time before the start of the recording function or automatic telephone answering function is set for the telephone numbers of all callers (hereinafter referred to as caller numbers). Therefore, in a situation in which the user of the portable terminal device would not normally use the portable terminal device (e.g., during a conference), upon receiving a call, the user must identify the caller's number shown on the display unit of the portable terminal device and distinguish between a caller for whom the user desires to make an immediate response and a caller the user may take some time before contacting.

As one conventional technique for a portable terminal device having an automatic telephone answering function, Japanese Laid-open Patent Application Heisei 10-190821 discloses an automatic telephone answering set that can remove a unwanted time during which a specific caller is kept waiting, without wasting memory for the recording of messages. The automatic telephone answering set captures a communication line in response to a call signal, transmits to the captured communication line a prerecorded response message, and records a message that arrives later along the communication line. This automatic telephone answering set comprises a storage means, a reception means, a determination means and a control means. The storage means stores telephone numbers. The reception means handles caller information that is received along the communication line upon the arrival of the call. The determination means determines whether the caller's telephone number, included in the caller information received by the reception means, is stored in the storage means. The control means then employs the results obtained by the determination means to set the time required for the capture of a communication line, and based on the time that is set, captures the communication line. Then, depending on whether the case is one wherein a call is received from a telephone number that has been stored in the telephone set in advance or one wherein a call is received from a telephone number that has not been stored, the automatic telephone answering set designates how long following the reception of the call that the caller must wait for the start of the automatic telephone answering function.

Japanese Laid-open Patent Application Heisei 11-8691 discloses an automatic telephone answering set that permits a user to quickly and precisely ascertain whether a message from a desired caller has been recorded. The automatic telephone answering set automatically captures a communication line upon the arrival of a call, records a message transmitted by a caller, and provides a notification on the display means that the message has been recorded. This automatic telephone answering set comprises a reception means, a comparison means and a control means. The reception means receives caller information that is transmitted along the communication line upon the arrival of a call. The comparison means compares, with telephone numbers stored in advance, the telephone number of a caller included in the caller information received by the reception means. The control means then controls the display means based on the results obtained by the comparison means.

Furthermore, Japanese Laid-open Patent Application Heisei 7-23095 discloses a telephone set that permits a user to easily ascertain whether a caller is a specific, registered person. The telephone set comprises an operating means, a telephone number storage means, a ring signal detection means, a telephone number detection means, a notifying means and a control means. The operating means inputs telephone number data. The telephone number storage means stores a telephone number input by the operating means. The ring signal detection means detects a ring signal received along a public line. The telephone number detection means detects telephone number data. The notifying means notifies a call in consonance with the ring signal detected by the ring signal detection means. And the control means permits the notifying means to notify the call when the telephone number detected by the telephone number detection means matches a telephone number stored in the storage means.

Further, Japanese Laid-open Patent Application 2000-165510 discloses a communication apparatus that has an automatic answering function and a toll saver function, and that can, without requiring much time, automatically respond to a call from a caller for whom it is not necessary to confirm the recording of message. The communication apparatus includes an automatic answering function for automatically responding to the arrival of a call and for storing received data, and a toll saver function for automatically using a different period of time for a response, depending on whether data is stored by the automatic answering function.

According to Japanese Laid-open Patent Application Heisei 10-190821, the memory disclosed as the storage means is used to store specific caller numbers in order to designate the time, following the arrival of a call, a caller must wait for the automatic telephone function to be activated. For the specific caller numbers stored in the memory, important or necessary telephone numbers (e.g., the above described caller numbers to which the user should immediately respond upon receiving a call) are not distinguished from the less important or less necessary telephone numbers (e.g., caller numbers for callers that the user may take time to contact). Moreover, when specific caller numbers stored in the memory are used as a telephone book, the time a caller must wait before the start of the automatic telephone answering function can not be designated in accordance with whether the telephone number is important or necessary or is less important or less necessary.

Thus, a need exists for a portable terminal device that can employ telephone numbers stored in advance as a telephone book, that can distinguish important or necessary telephone numbers (e.g., the above described caller numbers to which the user should immediately respond) from the less important or less necessary telephone numbers (e.g., caller numbers for callers that the user may take time before contacting), and that can control the time a caller must wait for the start of the automatic telephone answering function.

### SUMMARY OF THE INVENTION

The present invention is devised in view of the above-described problems. An object of the present invention is to provide a portable terminal device, the usability of which is improved when an automatic telephone answering function is employed.

It is another objective of the present invention to provide a portable terminal device that can selectively transfer a call received from a caller to an automatic telephone answering function.

It is an additional objective of the present invention to provide a portable terminal device the operability of which is improved by providing a preference for a call received from a caller.

To achieve the above problems, a portable terminal device of the present invention comprises answering means for automatically answering a call, storage means for storing at least one telephone number and reference information corresponding to said telephone number, comparing means for comparing a number included in said call with said telephone number stored in said storing means and controlling means for controlling the time from arrival of said call to start of said answering means, referring to said reference information, on the basis of the result of said comparing means. The portable terminal device further comprises inputting means for inputting said telephone number and said reference information. Said storing means may store a plurality of reference information. Said time is previously determined for each of said plurality of reference information, respectively. The portable terminal device further comprises another storing means for storing another reference information different from said reference information, and said controlling means preferably controls said time, referring to said another reference information, unless said number is equal to said telephone number on said comparing means. Said storing means may store the name of a remote user that corresponds to said telephone number, wherein said storing means is used as a telephone book. The portable terminal device further comprises a plurality of notifying means for notifying said arrival of said call, and said arrival of said call is notified by at least one of said plurality of notifying means that is determined on the basis of said reference information.

A method for controlling a telephone answering machine, comprises storing at least one telephone number and reference information corresponding to said telephone number, receiving a call, comparing a number included in said call with said telephone number and deciding the time for start of said telephone answering machine on the basis of said reference information that corresponds to said number included in said call. The method for controlling a telephone answering machine further comprises inputting said telephone number and said reference information. Said storing step may store a plurality of reference information. The method for controlling a telephone answering machine further comprises determining said time for each of said plurality of reference information, respectively. The method for controlling a telephone answering machine may comprise storing another reference information different from said reference information, and determining said time, referring to said another reference information, unless said number is equal to said telephone number on said comparing step. The method for controlling a telephone answering machine further comprises notifying said arrival of said call in a different type on the basis of said reference information.

According to the present invention, therefore, the usability of the portable terminal device is improved when the automatic telephone answering function is employed. And then, the portable terminal device can selectively transfer a call from a caller to the automatic telephone answering function. Moreover, the operation of the portable terminal device can be improved by providing a preference level for a call from a caller.

### BRIEF DESCRIPTION OF THE DRAWINGS

These and other objects, features and advantages of the invention will become more fully apparent from the following detailed description taken in conjunction with accompanying drawings.

FIG. 1 is a block diagram showing the schematic configuration of a portable terminal device according to the present invention;

FIG. 2 is a diagram showing the correlation between the telephone numbers, names and preference levels that are stored in the telephone number storage unit 3 shown in FIG. 1;

FIG. 3 is a flowchart showing the processing performed by the portable terminal device according to the present invention;

FIG. 4 is a diagram showing another correlation between the telephone numbers, names and preference levels that are stored in the telephone number storage unit of the portable terminal device according to the present invention; and

FIG. 5 is a flowchart showing another processing performed by the portable terminal device according to the present invention.

### DETAILED DESCRIPTION OF THE PREFERRED EMBODIMENT

Hereinafter, each embodiment of the present invention will be described in detail with reference to the drawings.

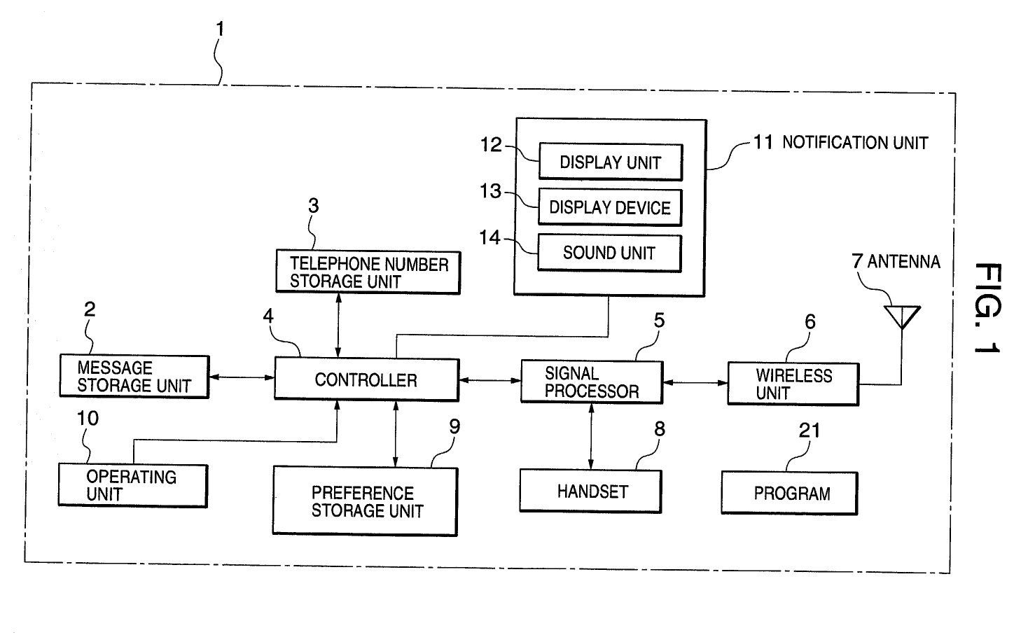

FIG. 1 is a block diagram showing the schematic configuration of a portable terminal device according to the present invention. As is shown in FIG. 1, reference numeral 1 denotes a portable terminal device according to the present invention. The portable terminal device 1 is a portable terminal device having an automatic telephone answering function. The portable terminal device 1 comprises a message storage unit 2, a telephone number storage unit 3, a controller 4, a signal processor 5, a wireless unit 6, an antenna 7, a hand set 8, a preference storage unit 9, an operating unit 10, a notification unit 11 and a program 21. The wireless unit 6 is connected to the antenna 7. The signal processor 5 is connected to the wireless unit 6 and the handset 8. The controller 4 is connected to the message storage unit 2, the telephone number storage unit 3, the signal processor 5, the preference storage unit 9 and the operating unit 10. To notify a user a call has been received from a caller, the notification unit 11 includes a display unit 12 for displaying an image, a display device 13 having an LED for presenting an optical display and a sound unit 14 for outputting a sound.

The wireless unit 6 modulates or demodulates a transmit-receive (TR) signal for transmission or reception at the antenna 7. When the wireless unit 6 transmits or receives a TR signal, the TR signal includes a voice signal that is used to identify the voices of the caller and the user who employs the portable terminal device 1. Further, when the wireless unit 6 receives a TR signal upon the arrival of a call, the TR signal further includes a caller number from the caller. The handset 8 is used to input and output speech. The signal processor 5 encodes a TR signal, and performs analog/digital conversion to convert into speech a voice signal that is included in the TR signal transmitted to the handset 8. Further, the signal processor 5 converts speech received from the handset 8 into a voice signal. The user of the portable terminal device 1 manipulates the operating unit 10. With the operating unit 10, the user changes the contents of the display unit 12, or the operating mode. The changing of the operating mode by the user includes the setting and canceling of the automatic telephone answering function.

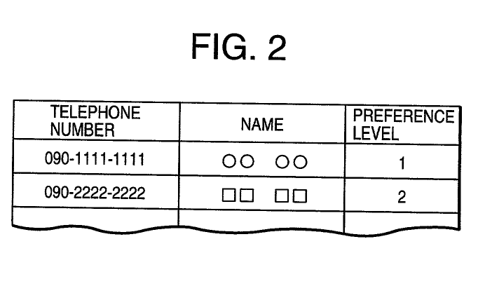

The message storage unit 2 is used to store a voice message for a caller that is released upon the arrival of a call and that indicates the call can not be responded to. This voice message is stored in the message storage unit 2 in advance as a no-response voice signal, and is transmitted to a caller when a call from a sender can not be answered. The message storage unit 2 is used to store a message from a caller, with the date, when the call is transferred to the automatic telephone answering function. A message received from the caller upon the transmission to the automatic telephone answering function is stored as a voice signal message in the message storage unit 2. The telephone number storage unit 3 is used to store telephone numbers for a plurality of remote users, the names of the plurality of remote users that correspond to these telephone numbers, and preference information that corresponds to each of the telephone numbers of the remote users, as shown in FIG. 2. Before the arrival of a call, the user employs the operating unit 10 to enter the telephone number of a remote user and the name of the remote user that corresponds to the telephone number, and also to enter preference information that corresponds to the telephone number of the remote user that has been entered. The telephone number storage unit 3 is used to store the telephone number, the name and the preference information for the remote user that are entered by the operating unit 10. The preference information, which is stored in the telephone number storage unit 3 to designate a control condition to be employed by the controller 4, has two levels: “1” for a high preference (the preference order is high) and “2” for a low preference (the preference order is low). Either “1” for a high preference or “2” for a low preference is set as the preference information that corresponds to each of the telephone numbers of the remote users that are entered by the user. Further, at the time of dialing, the telephone number storage unit 3 is used as a telephone book by the operating unit 10. The preference storage unit 9 is used to store other preference information. When, upon the arrival of a call, the controller 4 compares the caller number of the caller with the telephone numbers stored in the telephone number storage unit 3 and determines that there is no match, the controller 4 reads the preference information from the preference storage unit 9. Before the arrival of a call, the user employs the operating unit 10 to enter the preference information in a case wherein the caller number of a caller does not correspond to any telephone number stored in the telephone number storage unit 3. The preference storage unit 9 is used to store the preference information entered by the operating unit 10 in a case wherein the caller number does not correspond to any stored telephone number. The preference information, which is stored in the preference storage unit 9 and which designates the control condition used by the controller 4, has two levels: “1” for high preference and a “2” for low preference. Before the arrival of a call, “1” for high preference or “2” for low preference is set as the preference information in a case wherein the caller number does not correspond to a telephone number that has been entered by the user and that is stored in the telephone number storage unit 3.

Upon the arrival of a call, the controller 4 receives a TR signal from the signal processor 5 to indicate that a call has arrived, and obtains the caller number of the caller included in the TR signal. The controller 4 compares the caller number of the caller, which is included in the TR signal of the call that was received, with the telephone numbers stored in the telephone number storage unit 3. When a matching number is found, the preference information that corresponds to the matched telephone number (caller number) is read from the telephone number storage unit 3. When a matching telephone number is not found, the controller 4 reads the preference information from the preference storage unit 9. The controller 4 compares, with set preference “1”, the preference level indicated by the preference information that is read. When, as a result of the comparison, it is found that the preference level matches the set preference level, based on the preference “1”, the waiting time for the caller (a remote user) is calculated, beginning the time of the arrival of the call and continuing up to the start of the automatic telephone answering function. On the other hand, when as a result of the comparison, it is not found that the preference level matches the set preference level, based on the preference “2”, the waiting time for the caller (a remote user) is calculated, beginning the time of the arrival of the call and continuing up to the start of the automatic telephone answering function. In this case, the waiting time for the caller corresponds to the start time for the automatic telephone answering function. The start time for the automatic telephone answering function, which is controlled by the controller 4 when the preference information indicates a preference “1”, is longer than that controlled by the controller 4 when the preference information indicates a preference “2”. The controller 4 controls the notification unit 11 including the display unit 12, the display device 13 and the sound unit 14 to notify the user of the arrival of a call. When, as a result of a comparison, a match is found for the caller number, the controller 4 controls the display unit 12 to display at least one of a telephone number (the caller number received from the caller) stored in the telephone number storage unit 3 and the name corresponding to the telephone number. When a matching number is not found, the controller 4 controls the display unit 12 to display the caller number received from the caller. Further, a display, for example, of two or more colors can be presented by the LED included in the display device 13. Therefore, when, as a result of a comparison, a match is found for the caller number, the controller 4 controls the display device 13 to display a first color. When a match for the caller number is not found, the controller 4 controls the display device 13 to display a second color, differing from the first color. Furthermore, the controller 4 also controls the sound unit 14 to generate a first tone when as a result of the comparison a match for the caller number is found, or to generate a second tone when a match for the caller number is not found. The controller 4 controls the signal processor 5, so that upon the arrival of a call a process to converse with the caller is performed when the speech-enabled state (hereinafter referred to as off-hook) is provided by the operating unit 10. In the process for conversing with a caller, the controller 4 permits the signal processor 5 to convert, into speech, a voice signal included in a TR signal transmitted to the handset 8, and to convert speech received from the handset 8 into a voice signal. In addition, when the automatic telephone answering function initiation time is reached without the off-hook state being set, upon the transmission to the automatic telephone answering function, the controller 4 controls the signal processor 5 to perform the process for conversing with the caller. During the speech process at the time of the transmission to the automatic answering function, the controller 4 permits the signal processor 5 to transmit to a caller a voice message that is a no-response voice signal stored in the message storage unit 2, and to store in the message storage unit 2 a voice signal message that is received from a caller at the time of the transmission to the automatic answering function.

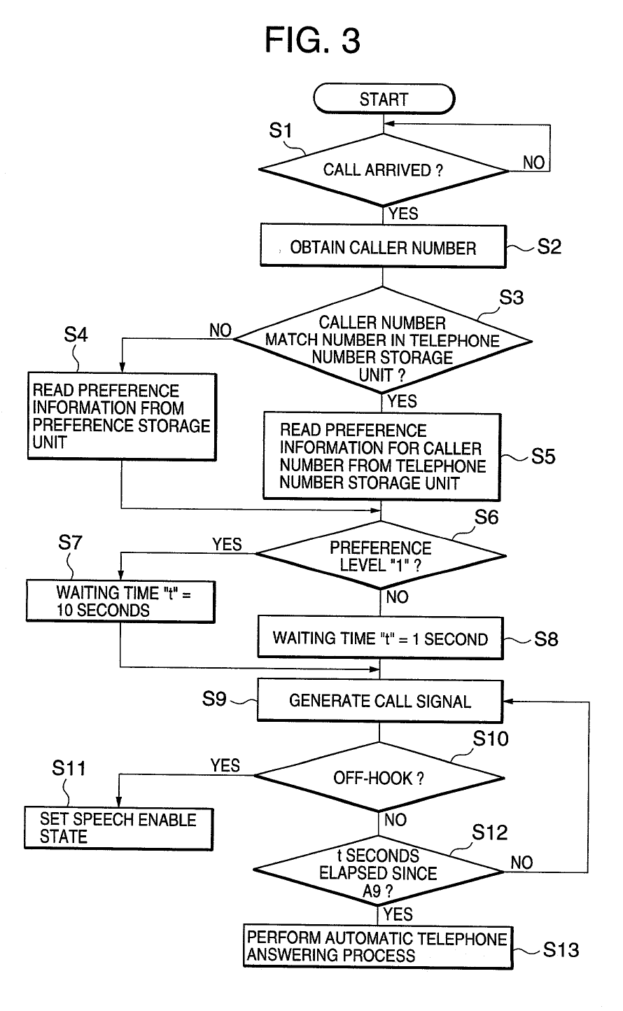

The operation of the portable terminal device 1 of the present invention will now be explained while referring to FIG. 3. Assume that the automatic telephone answering function of the portable terminal device 1 is set by the operating unit 10. Only the processing performed by the portable terminal device 1 upon the arrival of a call will now be described, no description of the other processing will be given. Also assume that the program 21 permits a computer to perform the processing shown in FIG. 3. FIG. 3 is a flowchart showing the processing performed by the portable terminal device according to the present invention.

As is shown in FIG. 3, when the portable terminal device 1 of a user does not receive a call from a caller (NO at S1), S1 is repeated until a call is received. When a caller dials the user and when the portable terminal device 1 receives the call (YES at S1), the controller 4 ascertains the call has arrived upon receiving a TR signal from the signal processor 5 via the antenna 7 and the wireless unit 6, and obtains the caller number for the caller, which is included in the TR signal (S2). Then, the controller 4 compares the caller number of the caller included in the TR signal, with the telephone numbers stored in the telephone number storage unit 3 (S3). When as a result of the comparison it is found that the caller number matches one of the telephone numbers (YES at S3), the controller 4 reads from the telephone number storage unit 3 preference information that corresponds to the matched telephone number (caller number) (S5). When as a result of the comparison it is found the caller number does not match any of the telephone numbers (NO at S3), the controller 4 reads preference information from the preference storage unit 9 (S4). Next, the controller 4 compares set preference “1” with the preference level indicated by the preference information that has been read (S6). When as a result of the comparison it is found the preference level matches the set preference (YES at S6), based on the preference “1”, the controller 4 controls/sets a time “t”, for example, ten seconds, beginning upon the arrival of the call, during which the caller (a remote user) must wait for the start of the automatic telephone answering function (S7). When as a result of the comparison it is found the preference level does not match the set preference (NO at S6), based on preference “2”, the controller 4 controls/sets time “t”, for example, ten seconds, beginning upon the arrival of the call, during which the caller (a remote user) must wait for the start of the automatic telephone answering function (S8).

Then, the controller 4 generates a call signal and employs the call signal to permit the notification unit 11 to notify the user that the call has arrived (S9). As is described above, based on the call signal at S9, the controller 4 permits the display unit 12 to display, when the process at S5 is performed, at least one of a telephone number (the caller number of the caller) stored in the telephone number storage unit 3 and the name corresponding to this telephone number, or permits the display unit 12 to display the caller number of the caller when the process at S4 is performed. Further, based on the call signal at S9, the controller 4 permits the display device 13 to display a first color when the process at S5 is performed, or permits the display device 13 to display a second color, which differs from the first color, when the process at S4 is performed. In addition, based on the call signal at S9, the controller 4 permits the sound unit 14 to generate a first sound when the process at S5 is performed, or permits the sound unit 14 to generate a second sound, which differs from the first sound, when the process at S4 is performed. Furthermore, the controller 4 determines whether the off-hook state is set by manipulating the operating unit 10 while the call signal is being generated (S10). The controller 4 determines the off-hook state is set when a speech enable signal, generated by the depression, for example, of a speech enabled button (not shown) of the operating unit 10, is received from the operating unit 10. When the off-hook state is set as a result of the decision (YES at S10), the controller 4 permits the signal processor 5 to convert into speech a voice signal transmitted to the handset 8 and to convert into a voice signal speech entered from the handset 8, and sets the speech enable state (S11). When the off-hook state is not set as a result of the determination (NO at S10), the controller 4 determines whether the waiting time “t” has elapsed since the process at S9 was performed (S12). When as a result of the determination it is found “t” seconds have not elapsed (NO at S12), the process at S9 to S12 is repeated. When “t” seconds have elapsed (YES at S12), i.e., when the start time has been reached for the automatic telephone answering function while the off-hook state is not set, as the automatic telephone answering process, the controller 4 permits the signal processor 5 to set the speech enable state for the caller, to transmit to the caller a no-response voice signal stored in the message storage unit 2 as a voice message, and to store in the message storage unit 2 the message from the caller as a voice signal message (S13).

As is described above, the portable terminal device 1 of the present invention can employ telephone numbers stored in advance as a telephone book to distinguish important or necessary telephone numbers (the above described caller numbers to which the user should immediately respond upon the arrival of a call) from less important or less necessary telephone numbers (e.g., caller numbers for a caller that the user can take time to contact), and can control the time during which the caller waits, following the arrival of the call, for the start of the automatic telephone answering function. With this arrangement, the portable terminal device 1 of the present invention can employ the preference information that is set in advance to change the waiting time required for the call to be transferred to the automatic telephone answering function. Therefore, the usability of the portable terminal device 1 is improved when the automatic telephone answering function is employed. According to the invention, when a call from a telephone number having a low preference is received, the portable terminal device 1 can transfer the call to the automatic telephone answering function after only a short waiting time, and when a call from a telephone number having a high preference is received, the waiting time for the transfer to the automatic telephone answering function can be extended. Therefore, a call from a caller having a low preference need not be responded to, and a call from a caller can be selectively transferred to the automatic telephone answering function. Further, since the preference information can be arbitrarily set by using the operating unit 10, the usability of the portable terminal device 1 of the invention is improved by providing the preference levels for calls from callers.

The portable terminal device 1 of the present invention is not limited to the above description. The waiting time “t” is set as ten seconds at S7 in FIG. 3, however, a period of time other than ten seconds may be set, or the user may employ the operating unit 10 to set the waiting time “t” before the arrival of a call. In addition to the above description for the portable terminal device 1 of the present invention, while the waiting time “t” is set as one second at S8 in FIG. 3, a waiting time other than one second may be set, or the user may employ the operating unit 10 to set the waiting time before the arrival of a call. In this case, it is preferable that the waiting time “t” designated by the controller 4 at S7 be longer than the waiting time “t” set by the controller 4 at S8. Further, for the portable terminal device 1 of the present invention, the preference levels that are indicated by the preference information stored in the telephone number storage unit 3 are not limited to the two preference levels “1” and “2”, and there may be M preference levels (M is an integer equal to or greater than 1). The preference levels that are indicated by the preference information stored in the preference information storage unit 9 are also not limited to the two levels “1” and “2”, and there may be N preference levels (N is an integer equal to or greater than 1).

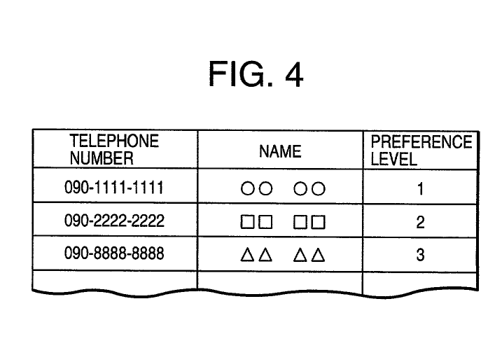

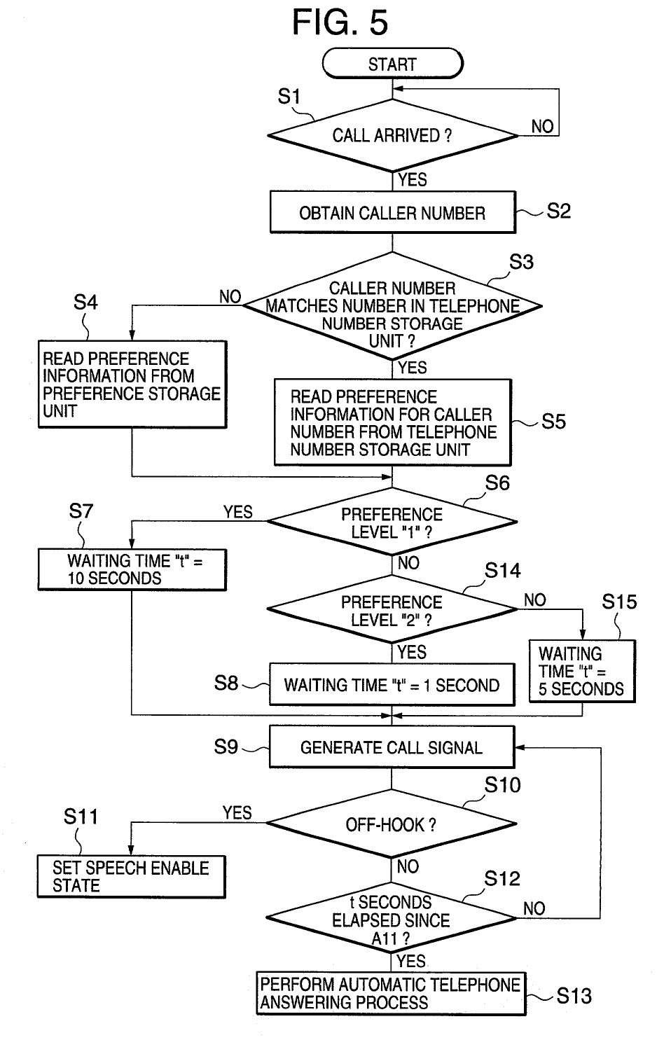

For example, when M is 3, as is shown in FIG. 4, the telephone numbers for a plurality of remote users, and the names and preference levels that correspond to the telephone numbers of these users are stored in the telephone number storage unit 3. The preference information stored in the telephone number storage unit 3 has three levels: “1”, for the highest preference (first in the preference order), “3”, for the lowest preference (last in the preference order), and “2”, between the preferences “1” and “3”. Other processing performed by the portable terminal device I of the present invention will now be described while referring to FIG. 5. For this processing, M is 3, and N as well, so that preference information stored in the preference information storage unit 9 has the three preference levels “1”, “2” and “3”. Further, S14 and S15 are added to the processing performed in FIG. 3 by the portable terminal device 1 of the invention. Further, the program 21 permits a computer to perform the processing shown in FIG. 5. FIG. 5 is a flowchart showing the another processing performed by the portable terminal device according to the present invention.

As is shown in FIG. 5, when a call is not received from a caller (NO at S1), the portable terminal device 1 operated by the user repeats S1 until a call from a caller does arrive. When a caller dials the user and when the portable terminal device 1 receives the call (YES at S1), the controller 4 ascertains a call has arrived after receiving a TR signal from the signal processor 5 via the antenna 7 and the wireless unit 6, and obtains the caller number of the caller included in the TR signal (S2). Then, the controller 4 compares the caller number of the caller included in the TR signal with the telephone numbers stored in the telephone number storage unit 3 (S3). When as a result of the comparison it is found the caller number matches a telephone number (YES at S3), the controller 4 reads from the telephone number storage unit 3 preference information that corresponds to the matched telephone number (the caller number) (S5). When, as a result of the comparison, it is found the caller number does not match a telephone number (NO at S3), the controller 4 reads preference information from the preference storage unit 9 (S4).

Next, the controller 4 compares with the set preference “1” the preference level indicated by the preference information that has been read (S6). When as a result of the comparison it is found the preference level matches the set preference (YES at S6), based on the preference “1” the controller 4 controls/sets to ten seconds, for example, a time t during which a caller (a remote user) must wait, following the arrival of a call, for the start of the automatic telephone answering function (S7). When as a result of the comparison, it is found the preference level does not match the set preference (NO at S6), the controller 4 compares, with the set preference “2”, a preference level other than “1” indicated by the preference information (S14). When as a result of a comparison a preference level other than “1” matches the set preference “2” (YES at S14), based on preference “2”, the controller 4 controls/sets to five seconds, for example, the time t during which a caller (a remote user) must wait, following the arrival of a call, for the start of the automatic telephone answering function (S15). And when as a result of a comparison it is found a preference level other than “1” does not match the set preference “2” (NO at S14), the controller 4 controls/sets to one second, for example, the time t a caller (a remote user) must wait, following the arrival of a call, for the start of the automatic telephone answering function (S8).

Then, the controller 4 generates a call signal, and employs the call signal to permit the notification unit 11 to notify the user that the call has arrived (S9). As is described above, based on the call signal at S9, the controller 4 permits the display unit 12 to display, when the process at S5 is performed, at least one of a telephone number (a caller number from a caller) stored in the telephone number storage unit 3 and the name corresponding to this telephone number, or permits the display unit 12 to display the caller number of the caller when the process at S4 is performed. Further, based on the call signal at S9, the controller 4 permits the display device 13 to display a first color when the process at S5 is performed, or permits the display device 13 to display a second color, differing from the first color, when the process at S4 is performed. In addition, based on the call signal at S9, the controller 4 permits the sound unit 14 to generate a first sound when the process at S5 is performed, or permits the sound unit 14 to generate a second sound, differing from the first sound, when the process at S4 is performed.

Furthermore, the controller 4 determines whether the off-hook state is set by manipulating the operating unit 10 while the call signal is generated (S10). The controller 4 determines the off-hook state has been set when a speech enable signal is generated by the depression, for example, of a speech enabled button (not shown) of the operating unit 10, and when the signal is received from the operating unit 10. When the off-hook state is set as a result of the determination (YES at S10), the controller 4 permits the signal processor 5 to convert into speech a voice signal transmitted to the handset 8 and to convert into a voice signal speech entered at the handset 8, and sets the speech enable state (S11). When the off-hook state is not set as a result of the determination (NO at S10), the controller 4 determines whether the waiting time t has elapsed since the process at A9 was performed (S12). When as a result of the determination it is ascertained t seconds have not elapsed (NO at S12), the process at S9 to S12 is repeated. When t seconds have elapsed (YES at S12), i.e., when the automatic telephone answering function start time has been reached while the off-hook state is not set, as the automatic telephone answering process, the controller 4 permits the signal processor 5 to set the speech enable state for the caller, to transmit to the caller an oral message that is a no-response speech signal stored in the message storage unit 2, and to store in the message storage unit 2 a message from the caller as a voice signal message (S13). As a result, the portable terminal device 1 of the present invention can expand the range for the setting of the preference level.

The portable terminal device 1 of the present invention explained while referring to FIG. 5 is not limited to this explanation. The waiting time t is set to five seconds at step S15 in FIG. 5, however, a waiting time other than five seconds may be set, or the user may employ the operating unit 10 to set the waiting time before the arrival of a call. In this case, it is preferable that the waiting time t designated by the controller 4 at S7 be longer than the waiting time t controlled by the controller 4 at S15, and that the waiting time t designated by the controller 4 at S15 be longer than the waiting time t controlled by the controller 4 at S8.

Obviously, numerous additional modifications and variations of the present invention are possible in light of the above teachings. It is, therefore, to be understood that within the scope of the appended claims, the invention may be practiced otherwise than as specifically described herein.

What is claimed is:

1. A portable terminal device, comprising:
answering means for automatically answering a call;
storage means for storing at least one telephone number and reference information corresponding to said telephone number;
comparing means for comparing a number included in said call with said telephone number stored in said storage means; and
controlling means for controlling the time from arrival of said call to start said answering means on the basis of the result of said comparing means and by referring to said reference information.

2. The portable terminal device as claimed in claim 1, further comprising inputting means for inputting said telephone number and said reference information.

3. The portable terminal device as claimed in claim 1, wherein said storage means stores a plurality of reference information.

4. The portable terminal device as claimed in claim 3, wherein said time is previously determined for each of said plurality of reference information, respectively.

5. The portable terminal device as claimed in claim 1, further comprising:
an additional storage means for storing additional reference information different from said reference information; and
wherein said controlling means controls said time by referring to said additional reference information, unless said number is equal to said telephone number on said comparing means.

6. The portable terminal device as claimed in claim 1, wherein said storage means stores the name of a remote user that corresponds to said telephone number, wherein said storage means is used as a telephone book.

7. The portable terminal device as claimed in claim 1, further comprising:
a plurality of notifying means for notifying said arrival of said call, and
wherein said arrival of said call is notified by at least one of said plurality of notifying means that is determined on the basis of said reference information.

8. A portable terminal device, comprising:
an answering machine that automatically answers a call;
a memory that stores at least one telephone number and reference information corresponding to said telephone number;
a comparator that compares a number included in said call with said telephone number stored in said memory; and
a controller that controls the time from arrival of said call to start of said answering machine on the basis of the result of said comparator and by referring to said reference information.

9. The portable terminal device as claimed in claim 8, further comprising an inputting unit that inputs said telephone number and said reference information.

10. The portable terminal device as claimed in claim 8, wherein said memory stores a plurality of reference information.

11. The portable terminal device as claimed in claim 10, wherein said time is previously determined for each of said plurality of reference information, respectively.

12. The portable terminal device as claimed in claim 8, further comprising:
an additional memory that stores additional reference information different from said reference information; and
wherein said controller controls said time, referring to said additional reference information, unless said number is equal to said telephone number on said comparator.

13. The portable terminal device as claimed in claim 8, wherein said memory stores the name of a remote user that corresponds to said telephone number, wherein said memory is used as a telephone book.

14. The portable terminal device as claimed in claim 8, further comprising:
a plurality of notifying units for notifying said arrival of said call; and
wherein said arrival of said call is notified by at least one of said plurality of notifying units that is determined on the basis of said reference information.

15. A method for controlling a telephone answering machine, comprising:
storing at least one telephone number and reference information corresponding to said telephone number;
receiving a call;
comparing a number included in said call with said telephone number; and
deciding the time for start of said telephone answering machine on the basis of said reference information that corresponds to said number included in said call.

16. The method for controlling a telephone answering machine as claimed in claim 15, further comprising inputting said telephone number and said reference information.

17. The method for controlling a telephone answering machine as claimed in claim 15, wherein said storing at least one telephone number stores a plurality of reference information.

18. The method for controlling a telephone answering machine as claimed in claim 17, further comprising determining said time for each of said plurality of reference information, respectively.

19. The method for controlling a telephone answering machine as claimed in claim 15, further comprising:
storing another reference information different from said reference information; and
determining said time by referring to said another reference information, unless said number is equal to said telephone number during said comparing of said number included in said call.

20. The method for controlling a telephone answering machine as claimed in claim 15, further comprising notifying said arrival of said call in a different type on the basis of said reference information.
